(19) United States
(12) Patent Application Publication
(10) Pub. No.: US 2012/0130818 A1
(43) Pub. Date: May 24, 2012

(54) ADVERTISEMENT OUTPUT CONTROL DEVICE, ADVERTISEMENT OUTPUT CONTROL METHOD, AND RECORDING MEDIUM

(75) Inventor: Masahiro Katsuki, Minato-ku (JP)

(73) Assignee: NEC CORPORATION, Minato-ku, Tokyo (JP)

(21) Appl. No.: 13/386,623

(22) PCT Filed: Jul. 15, 2010
(86) PCT No.: PCT/JP2010/061987

§ 371 Date: Jan. 23, 2012

(30) Foreign Application Priority Data
Jul. 24, 2009 (JP) 2009-173540

(51) Int. Cl. G06Q 30/02

(52) U.S. Cl. 705/14.58

(57) ABSTRACT

An advertisement output control device provided with an advertisement distribution unit (31) and a distribution-request acceptance unit (32). The advertisement distribution unit (31) generates arrival/departure slot information when receiving scheduled information on arrival and departure for each service from a transportation service management device (1), and supplies the generated information to the distribution-request acceptance unit (32). The distribution-request acceptance unit (32) generates advertisement spaces based on the arrival/departure slot information and accepts applications for advertisements from clients. Upon the acceptance of applications for advertisements, the distribution-request acceptance unit (32) supplies advertisement space information associated with contents to the advertisement distribution unit (31). The advertisement distribution unit (31) sets an advertisement schedule based on the advertisement space information. Thereafter, when receiving definite information on arrival and departure for each service from the transportation service management device (1), the advertisement distribution unit (31) discretionally changes the advertisement schedule and distributes content data to an output device (2).

### TECHNICAL FIELD

The present invention relates to an advertisement output control device, an advertisement output control system, an advertisement output control method, and a recording medium that controls an output of an advertisement to a display device like a display.

### BACKGROUND ART

An advertisement for commercial goods, services and/or the like, is carried out through a mass media like a TV, a radio, a newspaper, and a magazine, and a medium like a web page on the Internet.

Recently, there is an advertisement distribution system called a digital signage as a form of an advertisement which distributes an advertisement to a display installed in an outside location, in store and/or the like, and causes the display to display the advertisement.

Moreover, such a digital signage may be performed through a display which is installed at an airport, a train station or the like, in a transportation facility like an airplane or a railway (see, for example, Patent Literature 1).

More specifically, Patent Literature 1 discloses that a motion-picture advertisement is displayed on a large-scale display installed in a train station, a building, and an airport lobby by changing the rotation of several advertiser companies.

### PRIOR ART DOCUMENT

### Patent Literature

Patent Literature 1: Unexamined Japanese Patent Application Kokai Publication No. 2002-304574.

### DISCLOSURE OF INVENTION

### Problem to be Solved by the Invention

Meanwhile, an advertiser wants to place an advertisement with an advertisement effect as high as possible. More specifically, if the advertiser has a store for actually selling commercial goods, providing services, and/or the like, the advertiser wants to make the advertisement recognized by as many individuals as possible who are highly probable to visit the store, and considers a place to put the advertisement, for example, a place that as many individuals as possible within a distance that individuals may visit the store gather.

Since an arrival/departure place for vehicles regarding transportation facilities is a place where a large number of individuals gather for getting on/off the vehicles such a place is utilized for an advertiser to place an advertisement.

When selecting a place from a plurality of arrival/departure places to place an advertisement, an advertiser may think that, for example, individuals getting off the vehicles at the arrival/departure place closest to the store highly possibly visit the store, and may select the arrival/departure place closest to the store as a place for placing the advertisement.

More specifically, when placing an advertisement at an airport which is an arrival/departure place for airplanes, the advertiser may think about where to place an advertisement at the airport closest to the store. In this case, the target of the advertisement to be caused by the advertiser to recognize the advertisement is individuals getting off the airplane.

However, arrival/departure of airplanes is often changed from the schedule. Under such a circumstance, it is dubious whether or not individuals getting off the airplanes actually watch the advertisement if a motion-picture advertisement is merely output on an output device like a large-scale display in rotation.

Conversely, individuals getting on the airplanes at the airport may be taken as the target to be caused to recognize the advertisement.

For example, the advertiser can make the advertisement recognized by individuals who plan to get off the airplanes at the destination airport which is the closest airport to the store if the advertiser places the advertisement at the departure airport of the airplanes with the destination (an arrival place) that is the closest airport to the store.

Meanwhile, a plurality of airplanes which have different destinations depart from the airport where a large number of individuals gather. Therefore, at the departure airport, if the advertisement is displayed and changed merely by the rotation among several advertiser companies through the technique disclosed in the Patent Literature 1 and the like, depending on the change timing, there may be a possibility that most individuals who actually recognized the advertisement go to an airport that is not the closest airport to the advertisement target store.

Moreover, in this case, also, arrival/departure of airplanes is often changed from the schedule, and the target passengers have a possibility of not watching the advertisement depending on the change timing if the advertisement is displayed and changed merely by the rotation.

As described above, when an advertisement related to the arrival airport is output to an output device at the departure or destination airport, it is not easy to make the advertisement recognized adequately by the target individuals that the advertiser wants to recognize the advertisement, and the advertisement effect may decrease as a result in some cases. Hence, the advertiser becomes careful in placing the advertisement.

The present invention is made in view of the forgoing circumstance, and it is an object of the present invention to provide an advertisement output control device, an advertisement output control system, an advertisement output control method, and a recording medium, that are capable of appropriately enhancing an advertisement effect at arrival/departure places for vehicles

### Means for Solving the Problem

An advertisement output control device according to a first aspect of the present invention is connected to, through a communication network, an output device that is placed at a boarding/disembarking place of a vehicle in an arrival/departure place (an arrival place or a departure place) of the vehicle, and which causes the output device to output contents data for an advertisement, the advertisement output control device comprising: an arrival/departure-information acquisition unit that obtains scheduled arrival/departure information which is scheduled information relating to arrival and departure including a scheduled arrival/departure time of the vehicle at the arrival/departure place, and definite arrival/departure information which is definite information relating to arrival and departure including a definite arrival/departure time when the arrival/departure time of the vehicle at the arrival/departure place is fixed, the scheduled arrival/departure information obtained and definite arrival/departure information each being associated with a service identifier which identifies the service of the vehicle relating to arrival and departure; an advertisement-space generation unit that generates advertisement space information which includes advertisement spaces, organized for a plurality of services, indicating time and time periods for outputting the contents data to the output device and associated with the service identifiers based on the scheduled arrival/departure information; an advertisement-space-information storage unit that stores the advertisement space information where a predetermined advertisement space is associated with contents data for an advertisement to be output to the output device at the predetermined advertisement space; an open-advertisement-space output unit that outputs advertisement spaces, which are not associated with contents data in the advertisement space information stored in the advertisement-space-information storage unit, for making the advertisement spaces available to the public as open advertisement spaces; an advertisement-information acquisition unit that obtains an advertisement space which is selected among the open advertisement spaces output by the open-advertisement-space output unit, the obtained advertisement space being selected by a user who desires to output an advertisement, and contents data for an advertisement desired by the user to be output; a contents-data record unit which updates the advertisement space information by associating the advertisement space with the contents data, both obtained by the advertisement-information acquisition unit, and which records the updated information in the advertisement-space-information storage unit; a distribution management unit which generates a schedule for outputting the contents data to the output device as an advertisement schedule in association with the service identifier and the contents data based on the updated advertisement space information, and which changes, based on the definite arrival/departure information after obtaining the definite arrival/departure information, the advertisement schedule associated with a same service identifier as the service identifier associated with the definite arrival/departure information as a changed advertisement schedule; and an output control unit that performs a control of outputting contents data associated with the changed advertisement schedule to the output device in accordance with the changed advertisement schedule.

An advertisement output control system according to a second aspect of the present invention includes an output device which is placed in a facility where users of a vehicle stay or move, and an advertisement output control device which is connected to the output device through a communication network, and which executes a control of outputting an advertisement to the output device, the advertisement output control device comprising: an advertisement-space generation unit that generates advertisement space information which includes advertisement spaces, organized for a plurality of services, indicating time and time periods for outputting the contents data to the output device and associated with service identifiers identifying the services of the vehicles respectively, based on the scheduled arrival/departure information; an advertisement-information acquisition unit that obtains an advertisement space selected from the advertisement space information by a client of an advertisement, and contents data for the advertisement that is desired by the client to be output; an advertisement-space-information storage unit that stores the advertisement space information in association with the obtained contents data based on a service identifier associated with the advertisement space obtained by the advertisement-information acquisition unit; an arrival/departure-information acquisition unit that obtains the service identifier of the vehicle having definite arrival/departure time, and definite arrival/departure information; a distribution management unit which generates an advertisement schedule that is an output schedule of contents data to the output device based on advertisement space information associated with the contents data, and which changes the advertisement schedule as the changed advertisement schedule based on the definite arrival/departure information after obtaining the definite arrival/departure information; an output control unit that performs a control of transmitting the contents data subjected to be output based on the advertisement schedule to the output device in accordance with the changed advertisement schedule; and a transmission unit that transmits the contents data to the output device under the control by the output control unit, the output device comprising: a reception unit that receives the contents data transmitted from the advertisement output control device; and a display unit that displays an image based on the contents data received by the reception unit.

An advertisement output control method according to a third aspect of the present invention causes an output device to output contents data for an advertisement, the output device being connected to a communication network and being placed at a boarding/disembarking place of a vehicle in an arrival/departure place (an arrival place or a departure place) of the vehicle, the advertisement output control method comprising: a scheduled arrival/departure-information acquisition step of obtaining, in association with a service identifier that identifies a service of the vehicle relating to arrival and departure, scheduled arrival/departure information which is scheduled information relating to arrival and departure, and including a scheduled arrival/departure time of the vehicle at the arrival/departure place; an advertisement-space step of generating advertisement space information which includes advertisement spaces, organized for a plurality of services, indicating time and time periods for outputting the contents data to the output device associated with the service identifiers based on the scheduled arrival/departure information; an advertisement-space-information storage step of storing the advertisement space information where a predetermined advertisement space is associated with contents data for an advertisement to be output to the output device at the predetermined advertisement space; an open-advertisement-space output step of outputting advertisement spaces, which are not associated with contents data in the advertisement space information stored through the advertisement-space-information storage step, for making the advertisement spaces available to the public as open advertisement spaces; an advertisement-information acquisition step of obtaining an advertisement space which is selected among the open advertisement spaces output through the open-advertisement-space output unit, the obtained advertisement space being selected by a user who desires to output an advertisement, and contents data for an advertisement desired by the user to be output; a contents-data record step of updating the advertisement space information by associating the advertisement space obtained through the advertisement-information acquisition step with the contents data, and of recording the updated information in a predetermined storage unit; an advertisement-schedule generation step of generating a schedule for outputting the contents data to the output device as an advertisement schedule in association with the service identifier and the contents data based on the updated advertisement space information; a definite arrival/departure-information acquisition step of obtaining, when an arrival/departure time of the vehicle at the arrival/departure place is fixed, definite arrival/departure information in association with a service identifier that identifies a service of the vehicle relating to arrival and departure, the definite arrival/departure information being information relating to the arrival and the departure, and including the definite arrival/departure time; an advertisement-schedule change step of changing, after the definite arrival/departure information is obtained, the advertisement schedule associated with a same service identifier as the service identifier associated with the definite arrival/departure information based on the definite arrival/departure information as a changed advertisement schedule; and an output control step of performing a control of outputting contents data associated with the advertisement schedule to the output device in accordance with the changed advertisement schedule.

A computer-readable recording medium according to a fourth aspect of the present invention stores a program that causes an output device to output contents data for an advertisement, the output device being connected to a communication network and being placed at a boarding/disembarking place of a vehicle in an arrival/departure place (an arrival place or a departure place) of the vehicle, the program causing a computer to execute: a scheduled arrival/departure-information acquisition step of obtaining, in association with a service identifier that identifies a service of the vehicle relating to arrival and departure, scheduled arrival/departure information which is scheduled information relating to arrival and departure, and including a scheduled arrival/departure time of the vehicle at the arrival/departure place; an advertisement-space step of generating advertisement space information which includes advertisement spaces, organized for a plurality of services, indicating time and time periods for outputting the contents data to the output device associated with the service identifiers based on the scheduled arrival/departure information; an advertisement-space-information storage step of storing the advertisement space information where a predetermined advertisement space is associated with contents data for an advertisement to be output to the output device at the predetermined advertisement space; an open-advertisement-space output step of outputting advertisement spaces, which are not associated with contents data in the advertisement space information stored through the advertisement-space-information storage step, for making the advertisement space available to the public as an open advertisement space; an advertisement-information acquisition step of obtaining an advertisement space which is selected among the open advertisement spaces output through the open-advertisement-space output unit, the obtained advertisement space being selected by a user who desires to output an advertisement, and contents data for an advertisement desired by the user to be output; a contents-data record step of updating the advertisement space information by associating the advertisement space obtained through the advertisement-information acquisition step with the contents data, and of recording the updated information in a predetermined storage unit; an advertisement-schedule generation step of generating a schedule for outputting the contents data to the output device as an advertisement schedule in association with the service identifier and the contents data based on the updated advertisement space information; a definite arrival/departure-information acquisition step of obtaining, when an arrival/departure time of the vehicle at the arrival/departure place is fixed, definite arrival/departure information in association with a service identifier that identifies a service of the vehicle relating to arrival and departure, the definite arrival/departure information being information relating to the arrival and the departure, and including the definite arrival/departure time; an advertisement-schedule change step of changing, after the definite arrival/departure information is obtained, the advertisement schedule associated with a same service identifier as the service identifier associated with the definite arrival/departure information based on the definite arrival/departure information as a changed advertisement schedule; and an output control step of performing a control of outputting contents data associated with the advertisement schedule to the output device in accordance with the changed advertisement schedule.

### Effect of the Invention

According to the present invention, it becomes possible to appropriately enhance the advertisement effect of advertisements which are output at arrival/departure stations of vehicles.

### BRIEF DESCRIPTION OF DRAWINGS

FIG. 1 is an exemplary diagram showing an illustrative configuration of an advertisement output control system according to a first embodiment of the present invention;

FIG. 2 is an exemplary diagram for explaining procedures from generation of advertisement spaces to setting of an advertisement schedule according to the first embodiment;

FIG. 3 is an exemplary diagram for explaining procedures of controlling an output of an advertisement in accordance with actual operations according to the first embodiment;

FIG. 4 is an exemplary diagram for explaining procedures of generating advertisement spaces for departure services according to the first embodiment;

FIG. 5 is an exemplary diagram for explaining procedures of generating advertisement spaces for arrival services according to the first embodiment;

FIG. 6 is a flowchart for explaining an advertisement space process according to the first embodiment;

FIG. 7 is a flowchart for explaining an advertisement output control process according to the first embodiment;

FIG. 8 is an exemplary diagram showing an illustrative configuration of an advertisement output control system according to a second embodiment of the present invention; and

FIG. 9 is an exemplary diagram for explaining a tie between the advertisement space of a departure place and the advertisement space of a destination according to another embodiment of the present invention.

### BEST MODE FOR CARRYING OUT THE INVENTION

Explanation will be given below of embodiments of the present invention with reference to the accompanying drawings. In the following, as an example, the explanation will be given of a case in which the present invention is applied to a digital signage at airports. However, the following embodiments are described to give the explanation, but do not limit the scope and spirit of the present invention. Therefore, those skilled in the art may possibly adapt embodiments in which any or all elements are replaced with respective equivalents, and these embodiments should be included in the scope and spirit of the present invention.

### First Embodiment

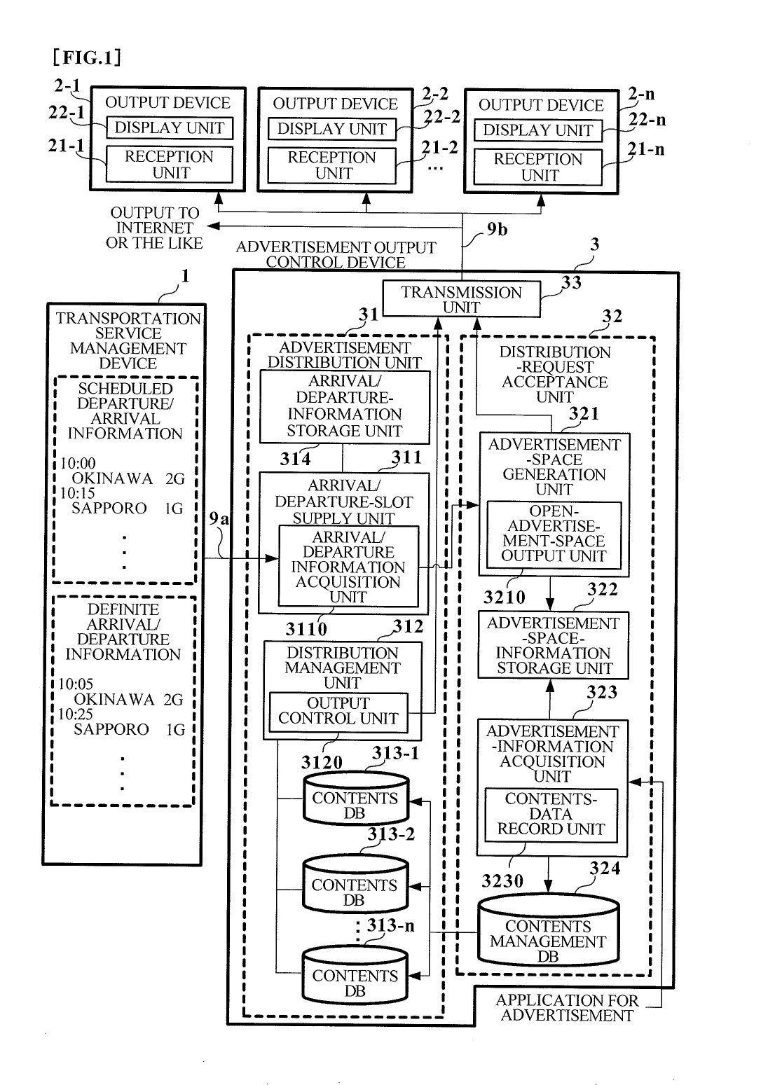

FIG. 1 is an exemplary diagram showing a configuration of an advertisement output control system according to a first embodiment of the present invention. As shown in the figure, the advertisement output control system according to the present embodiment includes output devices 2 (2-1 to 2-n) which individually output an advertisement, and an advertisement output control device 3 which controls the output of an advertisement to respective output devices 2. A transportation service management device 1 which manages the services of vehicles (hereinafter, explanation is given on the case in which a vehicle is an airplane as an example) is also included in FIG. 1 for a convenience of explanation.

The advertisement output control device 3 is connected to the transportation service management device 1 through a communication network 9a, and is also connected to the output devices 2 through a communication network 9b. Note that the communication network 9a and the communication network 9b may be the same network.

The transportation service management device 1 manages services of airplanes departing from an airport and airplanes arriving at the airport. More specifically, the transportation service management device 1 is, for example, a server or the like, and for each service of airplanes that arrive or depart, the transportation service management device 1 manages a scheduled arrival/departure time which is a scheduled time for arrival/departure set in advance, and a definite arrival/departure time which is time for arrival/departure fixed in actual operations of the vehicle. That is, for each of the departure services from the airport, the scheduled departure time and the definite departure time are managed, and for each of the arrival services, the scheduled arrival time and the definite arrival time are managed. Note that the departure time may be either one of the departure time of the service or the boarding time thereof. The transportation service management device 1 transmits the scheduled arrival/departure time in response to a request from the advertisement output control device 3 for example. Moreover, the transportation service management device 1 transmits the definite arrival/departure time to the advertisement output control device 3 immediately after such time schedules are fixed.

The output devices 2 (2-1 to 2-n) each includes a relatively large display device like a plasma display or a liquid crystal display, and an audio device like a speaker. The output devices 2 are disposed properly in respective facilities where airplane users stand by or move. The output device 2 is disposed at, for example, the proximity of a departure gate where the users scheduling to board on an airplane stand by before boarding, and/or the proximity of an arrival gate where the users getting off an airplane move. Note that when there are a plurality of respective kinds of gates, the output devices 2 are respectively disposed correspondingly to respective kinds of gates. The output device 2 includes a reception unit 21, and a display unit 22. The reception unit 21 receives contents data distributed from the advertisement output control device 3, and the display unit 22 displays an image for an advertisement and/or the like contained in the received contents data together with a sound in order to provide the advertisement to the users of the airplanes.

The advertisement output control device 3 includes an advertisement distribution unit 31, a distribution-request acceptance unit 32, and a transmission unit 33 that transmits contents data to the output devices 2. The advertisement output control device 3 is a server or the like, which has, for example, an arithmetic processing unit (as an example, a CPU (Central Processing Unit) or the like), a memory unit (as an example, a RAM (Random Access Memory), a ROM (Read Only Memory), a hard disk and/or the like), and a communication unit (as an example, an NIC (Network Interface Card) and/or the like). The arithmetic processing unit which operates based on a program or the like stored in the memory unit, the communication unit which is controlled by the arithmetic processing unit, the memory unit which stores necessary information, and the like function as respective components of the advertisement distribution unit 31 and the distribution-request acceptance unit 32. Note that the advertisement distribution unit 31 and the distribution-request acceptance unit 32 may be configured by different servers or the like.

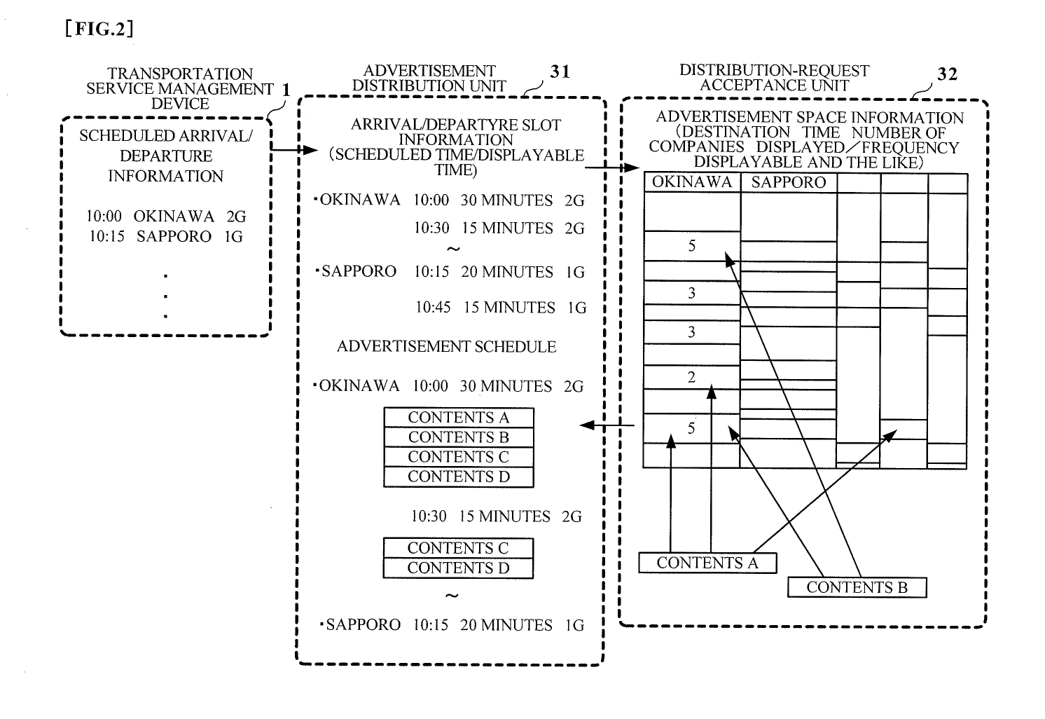

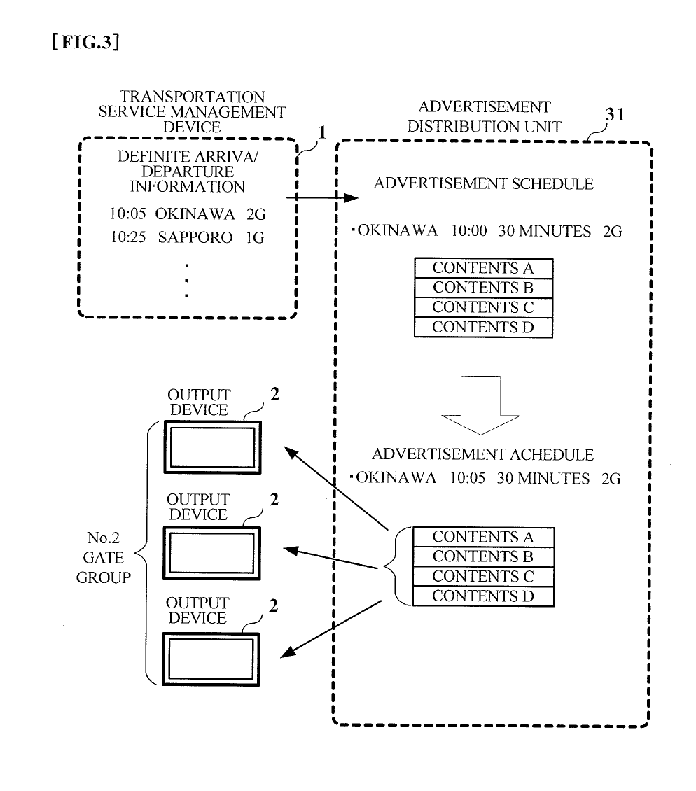

Explanation will be given of general configurations of the advertisement distribution unit 31 and the distribution-request acceptance unit 32 with reference to FIGS. 2 and 3.

First, explanation is given of procedures from generation of an advertisement space to setting of an advertisement schedule with reference to FIG. 2. The advertisement space is time and a time period to output an advertisement to the output devices 2.

The advertisement distribution unit 31 receives scheduled arrival/departure information including a scheduled time of arrival and departure (a scheduled arrival/departure time) and the like for each service from the transportation service management device 1. The scheduled arrival/departure information illustrated in the column of the transportation service management device 1 in FIG. 2 includes scheduled times of arrival and departure indicated as “10:00”, “10:15” and the like, the destination or the departure place of each service indicated as “OKINAWA” and “SAPPORO”, the arrival/departure gates (boarding/disembarking places) of the services indicated as “2G”, “1G” and the like. Note that the scheduled arrival/departure information also includes service identifier to identify each service, but it is not illustrated in FIG. 2. Moreover, a boarding/disembarking place identifier to identify the boarding/disembarking place can also be added in such information. Described “2G” and “1G” in the figure are examples.

Next, the advertisement distribution unit 31 obtains a practicable display time for an advertisement for the destination of each service and each gate thereof based on the scheduled arrival/departure information received, for example. The practicable display time is a time for which the target individuals for presentation of the advertisement are estimated to view the advertisement based on the arrival/departure time of the service, and is a time where it is significant to display the advertisement and which is determined that the advertisement can be displayed. For example, it is determined with reference to data like a time (a staying time) for which passengers are expected to be staying in the airport. Thereafter, to the distribution-request acceptance unit 32, the advertisement distribution unit 31 supplies the arrival/departure slot information including a service identifier, a scheduled arrival/departure time, and a practicable display time. The arrival/departure slot information illustrated in the column of the advertisement distribution unit 31 in FIG. 2 is an example of the arrival/departure slot information arranged for each destination. “OKINAWA” and “SAPPORO” are the destinations of respective services, “10:00”, “10:30” and the like are the scheduled departure time, “30 min”, “15 min” and the like are the practicable display time, and “2G”, “1 G” and the like indicate the arrival/departure gates of the services corresponding to the scheduled departure time. Note that no service identifier is clearly shown in FIG. 2.

The distribution-request acceptance unit 32 generates the advertisement space information based on the arrival/departure slot information supplied from the advertisement distribution unit 31. The advertisement space is the practicable display time associated with service information. Each advertisement space includes, for example, a service identifier which identifies the service of the vehicle, the destination/the departure place of the service, the time/the time period to display the advertisement, and a boarding/disembarking place identifier which identifies a boarding/disembarking gate where the advertisement is placed, and the number of displayed companies/allowable display frequency within each advertisement space and the like. As will be discussed later, a departure place identifier which identifies a departure place may be included in each advertisement space. The advertisement space information is the information that is obtained by organizing the advertisement spaces corresponding to respective services by destinations and departure places, for example. A client (an advertiser) selects a specific advertisement space among a plurality of advertisement spaces respectively corresponding to a plurality of services, and applies an advertisement together with provision of contents.

The distribution-request acceptance unit 32 accepts the application of an advertisement from the client, and stores the advertisement space information having the specific advertisement space which is selected by the client and associated with the contents provided and registered by the client (e.g., contents data uploaded by the client). According to an illustrative advertisement space information shown in the column of the distribution-request acceptance unit 32 in FIG. 2, each column in the horizontal direction in the table indicates a destination and each column in the vertical direction indicates time. Each gray portion is the advertisement space that indicates the practicable display time corresponding to the scheduled departure time of each service distinguished by the service identifier. The number written in the portion indicating each advertisement space represents the number of displayed companies or the allowable display frequency. The association between each contents and each advertisement space is simply indicated by an arrow put between each contents and each advertisement space. When a plurality of contents are associated with the same advertisement space, it represents that the plurality of contents are output to the output devices 2 during the time slot of the advertisement space.

The distribution-request acceptance unit 32 supplies the advertisement space information associated with the contents in this fashion to the advertisement distribution unit 31.

The advertisement distribution unit 31 sets an advertisement schedule based on the advertisement space information supplied from the distribution-request acceptance unit 32. The advertisement schedule defines the contents to be distributed to the output devices 2, the distribution time and period, and an identifier (a boarding/disembarking place identifier) to specify the output devices 2 when there are a plurality of output devices 2. As shown in FIG. 2, in the advertisement schedule for passengers of a service having the scheduled departure time “10:00” with the destination “OKINAWA” for example, contents A to D are output to the output device 2 at 2G, the second gate (the No. 2 gate), for the practicable display time of 30 minutes with reference to the departure time, i.e., from 9:30 to 10:00. The advertisement schedule shown in FIG. 2 is an example indicating an advertisement ending time and the practicable display time. A service identifier is added to this advertisement schedule, but not clearly shown in FIG. 2. Note that the advertisement schedule follows a service schedule (the scheduled arrival/departure information), and as will be discussed later, is discretionally changed in accordance with actual operations.

Next, explanation is given of procedures of controlling an output of an advertisement in accordance with actual operations with reference to FIG. 3.

After the arrival/departure time for each service is fixed, the transportation service management device 1 immediately transmits the fixed information to the advertisement distribution unit 31 as the definite arrival/departure information. The definite arrival/departure information may include a service identifier and the definite arrival/departure time. A boarding/disembarking place identifier which indicates a definite boarding/disembarking place (a boarding/disembarking gate in the case of an airplane) may be included therein.

Upon receiving the definite arrival/departure information, the advertisement distribution unit 31 discretionally changes the advertisement schedule based on the definite arrival/departure time and the like, and distributes the contents to the output devices 2 in accordance with the changed advertisement schedule. An example shown in FIG. 3 is an example case in which the definite arrival/departure time becomes 10:05 with the scheduled arrival/departure time being 10:00. Upon receiving of the definite arrival/departure time, the scheduled arrival/departure time of the advertisement schedule is changed to 10:05 which is the definite arrival/departure time, and the contents is distributed to the output devices 2 based on the changed advertisement schedule. FIG. 3 shows an example in which there are the plurality of output devices 2 which belong to the No. 2 gate.

In a case in which the advertisement schedule is set for departure services, for example, when receiving the definite departure time before the distribution time in the original advertisement schedule, the advertisement distribution unit 31 changes the advertisement schedule so as to start distributing the contents to the output devices 2 from a time that goes back from the definite departure time by a predetermined time. Since the advertisement schedule shown in FIG. 3 is shown for both arrival and departure, the time determined by going back is not clearly shown as an advertisement start time.

Conversely, in a case in which the advertisement schedule is set for arrival services, for example, regardless of the fact whether or not the distribution time in the original advertisement schedule has passed, the contents is distributed after the airplane of the service is actually arrived. That is, the advertisement distribution unit 31 changes the advertisement schedule after receiving the definite arrival time so as to start distributing the contents to the output devices 2 from the definite arrival time (or a few minutes later from the arrival).

Returning to FIG. 1, a detailed configuration of the advertisement output control device 3 and the like will be described. The advertisement output control device 3 includes the advertisement distribution unit 31, the distribution-request acceptance unit 32, and the transmission unit 33.

The transmission unit 33 transmits information from the advertisement output control device 3 to the exterior, e.g., transmits contents data to the output devices 2, and transmits open advertisement spaces for making the open advertisement spaces available to the public on the Internet.

The advertisement distribution unit 31 includes an arrival/departure-slot supply unit 311, a distribution management unit 312, contents DBs (Database) 313 (313-1 to 313-n), and an arrival/departure-information storage unit 314.

The arrival/departure-slot supply unit 311 includes an arrival/departure-information acquisition unit 3110. The arrival/departure-information acquisition unit 3110 obtains arrival/departure information for each service from the transportation service management device 1. The arrival/departure information includes the scheduled arrival/departure information and the definite arrival/departure information both described already. The arrival/departure information includes a service identifier, an arrival/departure time, and an arrival/departure gate (a boarding/disembarking place identifier)). As will be described later, a departure place identifier which identifies the departure place of the service may be also included. The scheduled arrival/departure information is transmitted from the transportation service management device 1 to the advertisement output control device 3 upon a request from the arrival/departure-information acquisition unit 3110, and the definite arrival/departure information is transmitted from the transportation service management device 1 to the advertisement output control device 3 immediately after the arrival/departure time is fixed. Note that the scheduled arrival/departure information may be transmitted at a predetermined time or at a predetermined time interval regardless of the request from the arrival/departure-information acquisition unit 3110.

The arrival/departure-slot supply unit 311 generates arrival/departure slot information including the practicable display time of advertisements based on the scheduled arrival/departure information obtained, and supplies the generated information to the distribution-request acceptance unit 32. The arrival/departure slot information includes, for example, a service identifier which identifies each service of airplanes, a scheduled arrival/departure time, a practicable display time of an advertisement, and a scheduled arrival/departure gate (which is identified by a boarding/disembarking place identifier). Note that when boarding/disembarking place identifier included in the scheduled arrival/departure information is distinguishingly indicated, it is referred to as a scheduled boarding/disembarking place identifier. Departure place identifiers may also be included in the arrival/departure information for the reason to be described later.

The distribution management unit 312 obtains the advertisement space information associated with the contents of the advertisement from the distribution-request acceptance unit 32, and sets an advertisement schedule. That is, the distribution management unit 312 sets the schedule for distributing contents data to the target output devices 2 which are identified by the boarding/disembarking place identifier for a predetermined time period at the time specified by each advertisement space of the advertisement space information.

The distribution management unit 312 includes an output control unit 3120. Upon receiving the definite arrival/departure information, the distribution management unit 312 discretionally changes the advertisement schedule based on the definite arrival/departure time. The output control unit 3120 controls the distribution of the contents data to the output devices 2 based on the changed advertisement schedule, and distributes the contents data to the output devices 2 through the transmission unit 33.

The contents DBs 313 (313-1 to 313-n) store contents data associated with advertisement spaces respectively. The contents data distributed to the output devices 2 through the output control unit 33 is the contents data stored in the contents DBs 313. Which contents data in the contents DBs 313 is distributed to the output devices 2 corresponding to the advertisement space is set in accordance with the advertisement schedule.

The arrival/departure-information storage unit 314 stores the scheduled arrival/departure information obtained by the arrival/departure-information acquisition unit 3110.

The distribution-request acceptance unit 32 includes an advertisement-space generation unit 321, an advertisement-space-information storage unit 322, an advertisement-information acquisition unit 323, and a contents management DB 324.

The advertisement-space generation unit 321 generates advertisement space information corresponding to each service of airplanes. The advertisement space information is generated based on the arrival/departure slot information supplied from the arrival/departure-slot supply unit 311, and is associated with a service identifier.

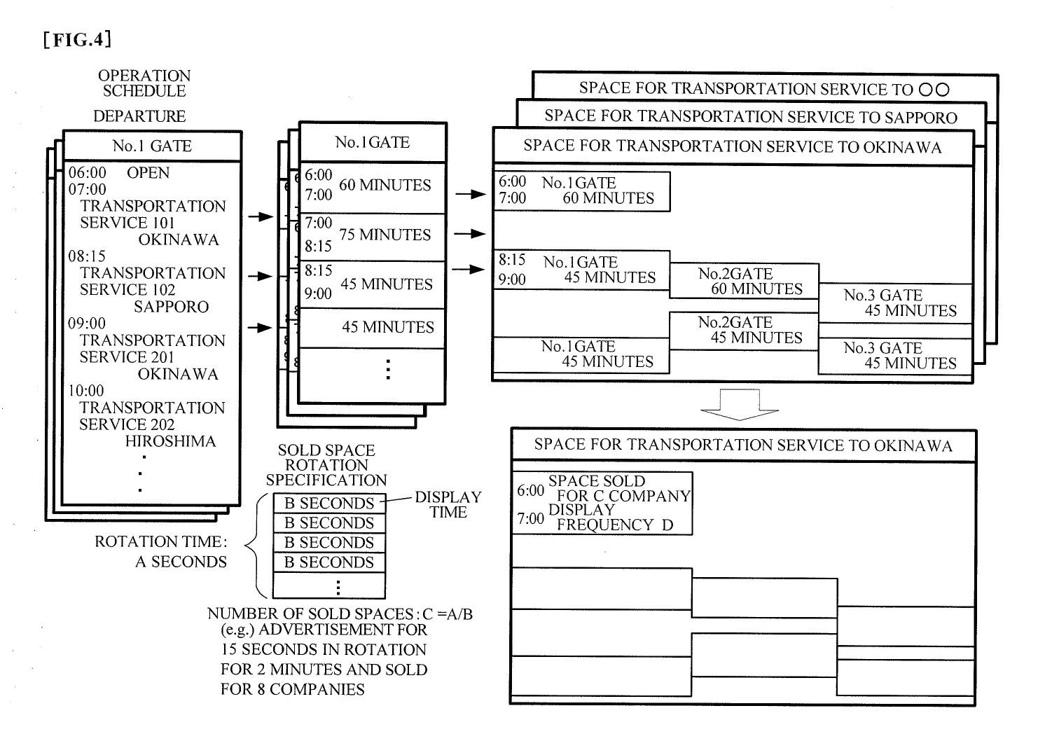

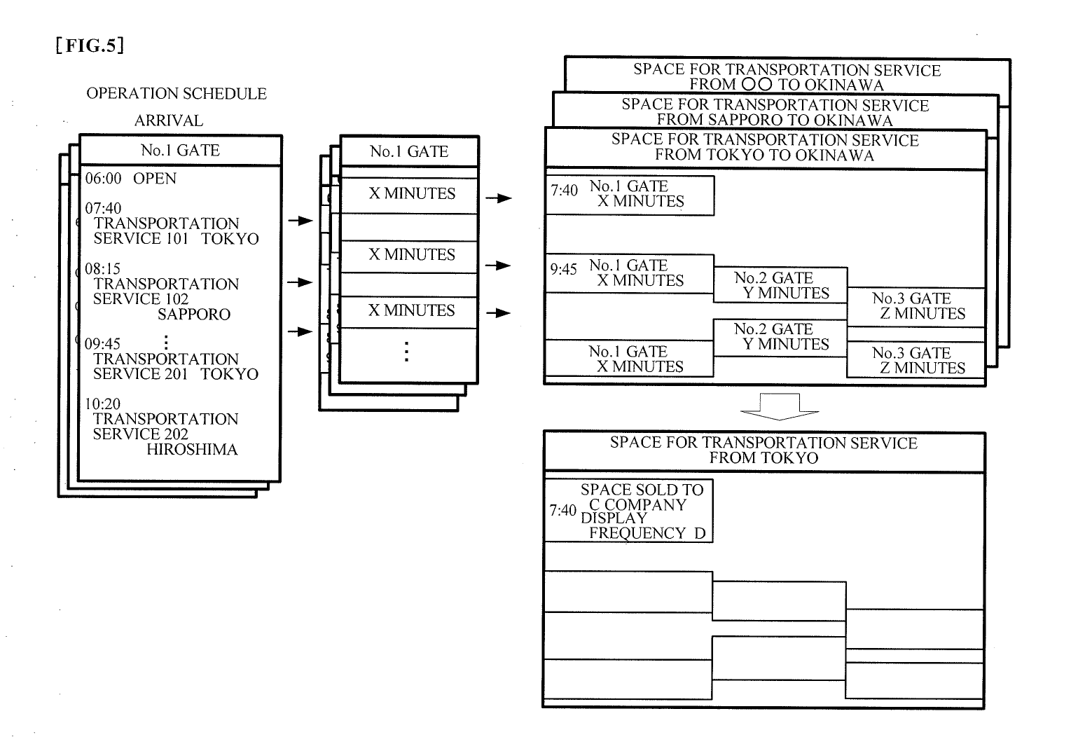

Procedures of generating advertisement space information by the advertisement-space generation unit 321 will be explained in detail with reference to FIGS. 4 and 5.

First, a procedure of generating advertisement slot information for a departure service will be explained with reference to FIG. 4. The advertisement-space generation unit 321 extracts, for each gate a service identifier (e.g., “service 101”), a scheduled departure time, and a practicable display time from a service schedule (see the upper left side figure described as “No. 1 gate” in FIG. 4) per each gate for each service of the airplanes departing from the airport which is included in the scheduled arrival/departure information through the arrival/departure slot information (see the upper middle figure described as “No. 1 gate” in FIG. 4) supplied by the arrival/departure-slot supply unit 311, and generates an advertisement space (see the upper middle figure described as “No. 1 gate” in FIG. 4). In this case, a time slot before the scheduled departure time of each service is generated as the advertisement space. Hence, the practicable display time for the service 101 bound for OKINAWA is 60 minutes from 6:00 which is the open time of the No. 1 gate, to 7:00 which is the departure time of the service 101. The practicable display time for the next service 102 bound for SAPPORO is 75 minutes from 7:00 which is the departure time of the service 101 to 8:15 which is the departure time of the service 102.

The advertisement-space generation unit 321 distributes such advertisement spaces for, for example, every destination of the services to generate the advertisement space information for each destination (see, the upper right side figure described as “space for service to OKINAWA” in FIG. 4). According to the illustrative advertisement space information shown in FIG. 4, gates are distinguished and shown for each row. Each advertisement space in the advertisement space information corresponds to the practicable display time of the advertisement, and each advertisement space is a target for sale. FIG. 4 shows illustrative advertisement space information having the advertisement space associated with contents data at the lower right side of the figure. This figure shows that the advertisement space from 6:00 to 7:00 at the No. 1 gate is sold to a C company (a sold space to the C company), and display frequency of the contents data which is calculated based on the display time period of the supplied contents is D times in the upper right side figure described as “space for service to OKINAWA”. The association of the advertisement space with the contents data will be described later.

Note that the advertisement-space generation unit 321 may divide each of the several advertisement spaces into small advertisement spaces, and a plurality of small advertisement spaces obtained in this fashion may be sold to a plurality of advertisers. As shown in the lower left side of FIG. 4, for example, the advertisement space for 2 minutes is divided into eight small advertisement spaces each for 15 seconds, and the eight spaces are sold to eight companies. In this case, respective contents of the eight companies are displayed on the output devices 2 in rotation. The display time period, the number of companies to be displayed, display frequency, and the like, are managed based on the advertisement schedule.

Next, a procedure of generating advertisement space information for an arrival service will be explained with reference to FIG. 5. The advertisement-space generation unit 321 extracts a service identifier, a scheduled departure time, and a practicable display time for each gate from a service schedule (see the upper left side figure described as “No. 1 gate” in FIG. 5) per a gate of each service arriving at the airport which is included in the scheduled arrival/departure information, and generates an advertisement space (see the upper middle figure described as “No. 1 gate” in FIG. 5). In this case, since a time slot after the scheduled arrival time for each service is generated as an advertisement space, only the practicable display time “X” is described in the example shown in FIG. 5.

The advertisement-space generation unit 321 distributes such advertisement spaces for, for example, every departure place of the services to generate the advertisement space information for each departure place (see the upper right side figure described as “space for service from TOKYO to OKINAWA” or the like, in FIG. 5: the departure place is TOKYO in this example). Since the layout and the target for sale in the advertisement space information are same as those in FIG. 4, the explanation thereof will be omitted. The lower right side figure described as “space for departure from TOKYO” in FIG. 5 is an example showing the advertisement space information having the advertisement space associated with contents, and also indicating that the advertisement space for X minutes of the practicable display time from 7:40 of the No. 1 gate is sold to the C company (a sold space to C company), the contents is associated therewith and the number of displaying of the contents which is calculated based on the display time period of the supplied contents is D times in the upper right side figure described as “space for service from TOKYO to OKINAWA”.

Note that some of such advertisement spaces may be each divided into the plurality of small advertisement spaces in the same fashion as shown in FIG. 4, and the plurality of small advertisement spaces may be sold to the plurality of advertisers.

The advertisement-space generation unit 321 includes an open-advertisement-space output unit 3210. The open-advertisement-space output unit 3210 extracts an advertisement space having no application for an advertisement yet from the advertisement space information, and outputs the information of the extracted spaces to, for example, a homepage or the like on the Internet through the transmission unit 33 to make the information of the extracted apaces available to the public. Therefore, the whole generated advertisement space information is made available to the public at first. The client for an advertisement (an advertiser) is able to view the advertisement space information made available to the public and to apply for the advertisement (or to purchase the space for an advertisement). After any application for the advertisement is done, the information of the advertisement spaces having no application for the advertisement yet is extracted from the advertisement space information and is made available to the public.

The advertisement-space-information storage unit 322 stores the advertisement space information (respective pieces of information shown in the upper right side and the lower right side of FIG. 4 and the upper right side and the lower right side of FIG. 5) generated by the advertisement-space generation unit 321. The advertisement space information which is not associated with contents data is stored in the advertisement-space-information storage unit 322 by the advertisement-space generation unit 321. The advertisement space information associated with contents data is stored in the advertisement-space-information storage unit 322 by a contents-data record unit 3230 to be described later.

The advertisement space information stored in the advertisement-space-information storage unit 322 is associated with contents data through the applications of advertisements by clients respectively as described later. Next, the advertisement space information associated with the contents data is supplied to the advertisement distribution unit 31 per every predetermined timing.

Returning to FIG. 1, the advertisement-information acquisition unit 323 obtains the advertisement space selected by the client, and the contents data of an advertisement supplied by the client. The client selects, for example, an advertisement space where the client wishes to display an advertisement, among the advertisement space information for every destination or for every departure place as shown in FIG. 4 or FIG. 5. Note that when the advertisement space is divided, the client selects a small advertisement space. Thereafter, contents data for the advertisement is uploaded to the advertisement output control device 3 through the advertisement-information acquisition unit 323.

The advertisement-information acquisition unit 323 includes the contents-data record unit 3230. The contents-data record unit 3230 stores the obtained contents data in the contents managing DB 324, and associates the contents (the contents data) with the advertisement space obtained through the selection by the client, thereby updating the advertisement space information stored in the advertisement-space-information storage unit 322.

The contents managing DB 324 stores the contents data obtained by the advertisement-information acquisition unit 323. Moreover, when the advertisement space information which is stored in the advertisement-space-information storage unit 322 and which is associated with the contents data is supplied to the advertisement distribution unit 31, when the advertisement-information acquisition unit 323 notifies the distribution management unit 312 that the association of the contents is completed and the distribution management unit 312 reads the advertisement space information from the advertisement-space-information storage unit 322, the contents data subjected to the association is read from the contents management DB 324, and is stored in the contents DBs 313.

As described above, the above-described advertisement-space generation unit 321 extracts, as open advertisement spaces, advertisement spaces which are not associated with contents data among the advertisement space information stored in the advertisement-space-information storage unit 322 through the open-advertisement-space output unit 3210, and outputs the open advertisement spaces in such a manner where the client for an advertisement can view the open advertisement spaces, for example like the publication on the Internet or the like to encourage the advertisement client to apply for an advertisement. Note that the open-advertisement-space output unit 3210 may be placed independently from the advertisement-space generation unit 321.

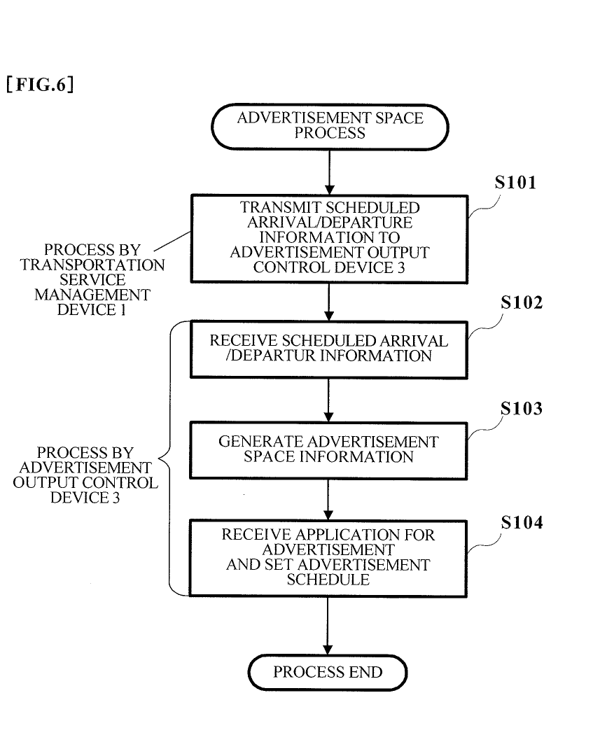

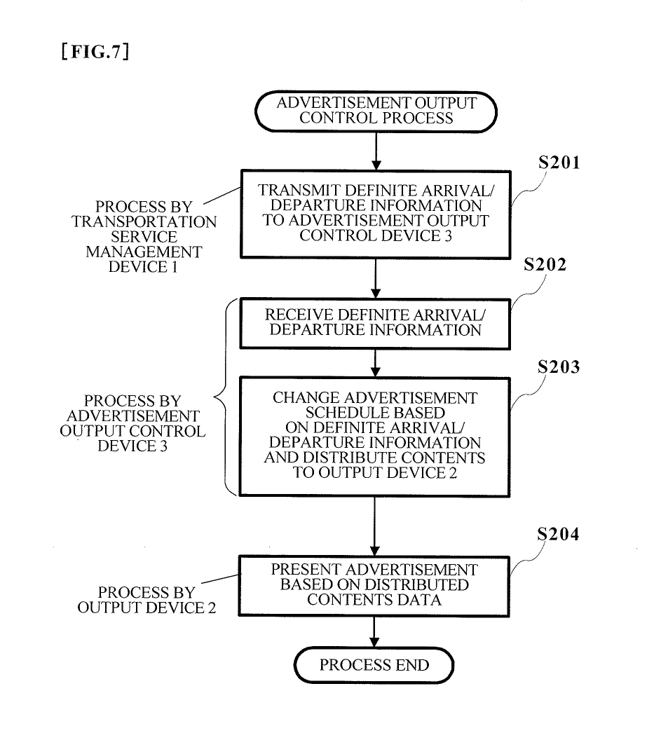

Next, the operation of the advertisement output control system employing such a configuration will be explained with reference to FIG. 6 and FIG. 7. FIG. 6 is a flowchart for explaining an advertisement space process according to the embodiment of the present invention. Moreover, FIG. 7 is a flowchart for explaining an advertisement output control process according to the embodiment of the present invention.

First, explanation will be given of the operation of the transportation service management device 1 and that of the advertisement output control device 3 with reference to the flowchart of FIG. 6 showing the advertisement space process.

First, the transportation service management device 1 transmits the scheduled arrival/departure information to the advertisement output control device 3 (step S101). For example, the transportation service management device 1 transmits the scheduled arrival/departure information (the scheduled arrival time, the scheduled departure time or the like) of each arrival or departure service to the arrival/departure-information acquisition unit 3110 of the advertisement distribution unit 31 in response to a request from the advertising output control device 3 (as a specific example, from the arrival/departure-information acquisition unit 3110). Note that the transportation service management device 1 may sequentially transmit the scheduled arrival/departure information to the advertisement distribution unit 31 per every certain timing.

The advertisement distribution unit 31 of the advertisement output control device 3 receives the scheduled arrival/departure information transmitted from the transportation service management device 1 through the arrival/departure-information acquisition unit 310 (step S102). Upon receiving the scheduled arrival/departure information of each service from the transportation service management device 1, the advertisement distribution unit 31 obtains the practicable display time for an advertisement for every destination or gate for example through the arrival/departure-slot supply unit 311 and supplies the arrival/departure slot information including the scheduled arrival/departure time and the practicable display time to the advertisement-space generation unit 321 of the distribution-request acceptance unit 32.

Next, the advertisement output control device 3 generates advertisement space information (step S103). That is, the advertisement-space generation unit 321 of the distribution-request acceptance unit 32 generates, for example, the advertisement space information for every destination or departure place as shown in FIG. 4 and FIG. 5 based on the arrival/departure slot information supplied from the arrival/departure-slot supply unit 311 of the advertisement distribution unit 31, and stores the generated information in the advertisement-space-information storage unit 322.

Next, the advertisement output control device 3 receives an application for an advertisement from the client, and sets an advertisement schedule (step S104). That is, the advertisement-information acquisition unit 323 of the distribution-request acceptance unit 32 receives the application for the advertisement from the client. The advertisement-information acquisition unit 323 stores, through the contents-data record unit 3230, the advertisement space, which is subjected to the application by the client among the advertisement space information in the advertisement-space-information storage unit 322, in association with the contents data which is registered at the time of application for the advertisement. The advertisement space information associated with the contents data in this fashion is supplied from the distribution-request acceptance unit 32 to the distribution management unit 312 of the advertisement distribution unit 31 through the advertisement-space-information storage unit 322 per every predetermined timing. At the time of supplying, the contents data which is associated with the advertisement space information and stored in the contents managing DB 324 is stored in the contents DBs 313.

The distribution management unit 312 of the advertisement distribution unit 31 sets the advertisement schedule which defines the contents data to be distributed to the output devices 2 and the distribution time and the distribution time period thereof based on the supplied advertisement space information. Through the above-explained procedures, the advertisement space process shown in FIG. 6 completes.

Next, explanation will be given of the operations of the transportation service management device 1, the advertisement output control device 3, and the output devices 2 with reference to the flowchart of FIG. 7 showing the advertisement output control process.

First, when the arrival/departure time for each service is fixed, the transportation service management device 1 immediately transmits the definite arrival/departure information to the advertisement output control device 3 (step S201).

The advertisement output control device 3 receives the definite arrival/departure information transmitted from the transportation service management device 1 through the arrival/departure-information acquisition unit 3110 of the advertisement distribution unit 31 (step S202).

The advertisement output control device 3 changes the advertisement schedule based on the received definite arrival/departure information, and distributes the contents to the output devices 2 (step S203). That is, the advertisement distribution unit 31 obtains, for example, the definite arrival/departure time (the definite arrival time and the definite departure time) from the received definite arrival/departure information. The distribution management unit 312 discretionally changes the advertisement schedule based on the definite arrival/departure time, and the output control unit 3120 distributes the contents to the output devices 2 through the transmission unit 33 in accordance with the changed advertisement schedule.

For example, in a case in which the advertisement schedule is set for the advertisement space corresponding to departure services, when receiving the definite departure time before the distribution time in the original advertisement schedule, the advertisement distribution unit 31 causes the distribution management unit 312 to change the advertisement schedule so as to start distributing the contents to the output devices 2 at time that goes back by predetermined time from the definite departure time.

Moreover, in a case in which the advertisement schedule is set for the advertisement space corresponding to arrival services, regardless of, for example, the distribution time in the original advertisement schedule, the advertisement distribution unit 31 distributes the contents after the definite arrival time of the service. That is, the distribution management unit 312 of the advertisement distribution unit 31 changes the advertisement schedule after receiving the definite arrival time so as to start distributing the contents to the output devices 2 at the definite arrival time (alternatively, at time after a few minutes from the definite arrival time).

The output devices 2 presents an advertisement based on the contents data distributed from the advertisement output control device 3 (step S204). For example, the output devices 2 display an image like an advertisement included in the distributed contents data together with sound in order to present the advertisement to the users of airplanes.

In this fashion, first, the advertisement space information for each service is generated through the advertisement space process, and the client is able to apply for the advertisement in the advertisement space corresponding to the desired service in consideration of the destination, the departure place, and the like. Moreover, the applied advertisement is output to the output devices 2 through the advertisement output control process in accordance with the actual arrival/departure status, i.e., the definite arrival/departure information. That is, the advertisement schedule is discretionally changed based on the definite arrival/departure time and the like, and the contents are distributed to the output devices 2.

Note that not only the arrival/departure time but also the boarding/disembarking place (identified by a scheduled boarding/disembarking place identifier) like the arrival/departure gate in the scheduled arrival/departure information may be changed by the definite arrival/departure information. The distribution management unit 312 determines whether or not the boarding/disembarking place identifier (the definite boarding/disembarking place identifier) indicating the boarding/disembarking place and included in the definite arrival/departure information is different from the scheduled boarding/disembarking place identifier in order to recognize the presence/absence of a change of the boarding/disembarking place, and changes the scheduled boarding/disembarking place identifier in the advertisement schedule to the definite boarding/disembarking place identifier when there is the change. The output control unit 3120 distributes the contents to the output devices 2 which are placed at the boarding/disembarking place that is identified by the definite boarding/disembarking place identifier in accordance with the changed advertisement schedule.

The boarding/disembarking place identifier (the scheduled boarding/disembarking place identifier and the definite boarding/disembarking place identifier) is for identifying boarding/disembarking places when there are a plurality of boarding/disembarking places within a predetermined arrival/departure place like the same airport. Providing that the output devices 2 are placed at boarding/disembarking places, respectively, the output devices 2 are identified one another through identification of the boarding/disembarking place based on the boarding/disembarking identifier. However, when the departure place and the destination are set as the advertisement places, it is insufficient with the boarding/disembarking place identifier only in order to identify the output devices 2. Since what is expected in the present invention is the advertisement for stores and the like, located near the destination of the vehicle, the destination is fixed. Conversely, there are a plurality of departure places. The departure place identifier is for identifying the destination at which an advertisement is desirable.

By the advertisement space information that includes the departure place identifier, the client becomes able to select the departure place identifier of the departure place where an advertisement effect can be expected other than the destination where the direct advertisement effect is expected, and is able to distribute the contents to the output devices 2 located near the boarding place of the selected departure place.

According to the device and the method configured as explained above, it becomes possible to appropriately present an advertisement to individuals actually getting off the airplane of the service and getting on the airplane of the service, thereby enhancing the advertisement effect.

### Second Embodiment

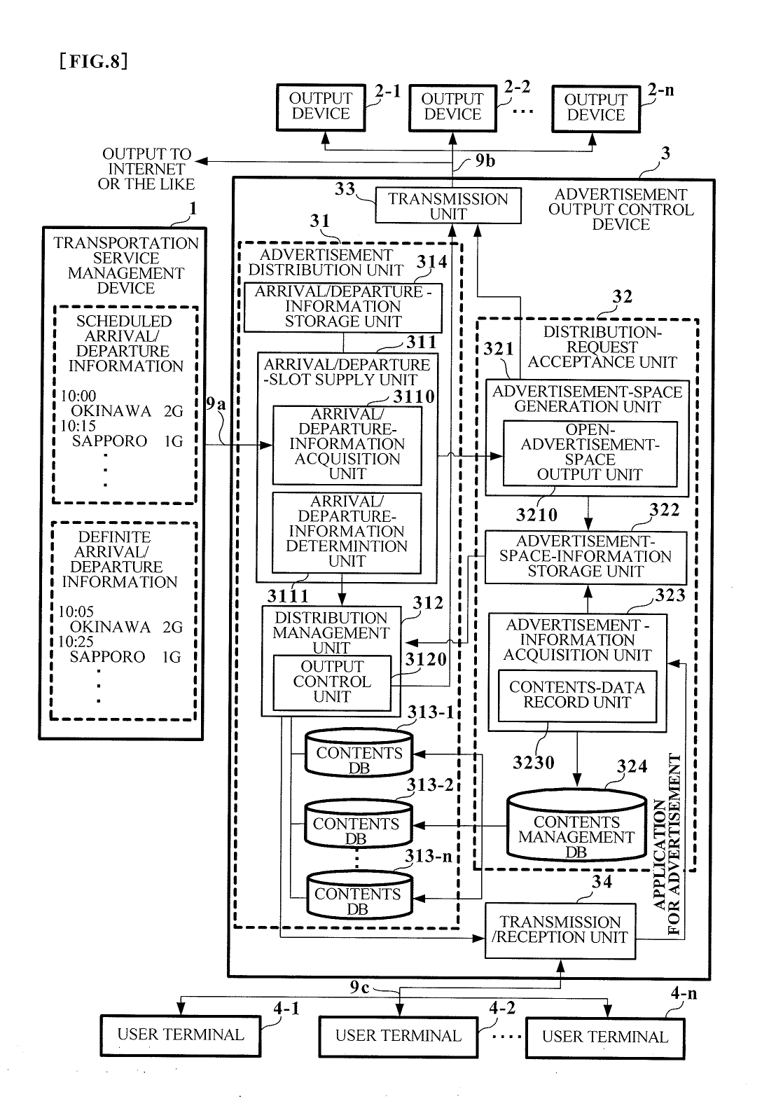

According to the second embodiment, when contents is distributed to output devices 2 based on an advertisement schedule which is discretionally changed based on a definite information, an advertisement output control device 3 supplies to a client an actual distribution result (an actual advertisement result) including such a change result. Explanation will be given below of an advertisement output control system which supplies an advertisement result to a client with reference to FIG. 8.

FIG. 8 is an exemplary diagram showing a configuration of the advertisement output control system according to the second embodiment of the present invention. The advertisement output control system according to the second embodiment includes output devices 2 (2-1 to 2-n), an advertisement output control device 3, and user terminals 4 (4-1 to 4-n). A transportation service management device 1 is illustrated in order to facilitate the explanation.

The advertisement output control device 3 is connected to the transportation service management device 1 through a communication network 9a like the first embodiment, and is also connected to the output devices 2 through a communication network 9b. Moreover, the advertisement output control device 3 is connected to the user terminals 4 through a communication network 9c. The advertisement output control device 3 further includes a transmission/reception unit 34 in addition to the configuration shown in FIG. 1. Information is exchanged between the advertisement output control device 3 and the user terminals 4 through the transmission/reception unit 34. Note that any pairs or all of the communication networks 9a, 9b, and 9c may be the common network.

Since the transportation service management device 1 and the output devices 2 are same as those of the above-described first embodiment, the duplicated explanation thereof will be omitted.

The advertisement output control device 3 is different from the above-described first embodiment in transmitting the advertisement result to the user terminals 4. That is, the advertisement distribution unit 31 of the advertisement output control device 3 transmits, to the user terminals 4, the actual distribution result of the contents to the output devices 2.

For example, an arrival/departure-slot supply unit 311 of the advertisement distribution unit 31 further includes an arrival/departure-information determination unit 3111. The arrival/departure-information determination unit 314 compares the distribution time of the contents to the output devices 2 based on the scheduled arrival/departure information with the actual distribution time of the contents based on the settled arrival/departure information, obtains the time difference, and determines whether or not the time difference is equal to or larger than a predetermined threshold value. This time difference can be obtained as the difference between the scheduled departure time and the definite departure time or the difference between the scheduled arrival time and the definite arrival time. Note that the arrival/departure-information determination unit 3111 may be provided independently from the arrival/departure-slot supply unit 311. In this case, the time difference can be calculated from an advertisement schedule and a changed advertisement schedule both corresponding to the same service identifier.

When it is determined that the time difference is equal to or larger than the threshold value, the advertisement distribution unit 31 transmits, to the user terminals 4, advertisement-time change information which indicates that the advertisement is placed at time that is largely different from the scheduled advertisement time. Regarding the advertisement-time change information, for example, the distribution management unit 312 receives the above determination result, and the output control unit 3120 controls the transmission of the advertisement-time change information to the user terminals 4. More specifically, the output control unit 3120 performs a control of extracting a client and the user terminal 4 of the client who has requested an advertisement to the corresponding advertisement space, and of distributing the advertisement-time change information to the extracted user terminal 4. In this case, a user identifier needs to be associated with the advertisement space at the time of the application for the advertisement. The user identifier is also associated with, for example, the advertisement schedule, and thus the output control unit 3120 can identify the client who has applied for the advertisement. Moreover, the user terminals 4 (4-1 to 4-n) are also added with the user identifier as described later. Therefore, the user terminal 4 can also be extracted.

The advertisement-time change information is controlled by the output control unit 3120, and is transmitted to the user terminals 4 through the transmission/reception unit 34. Note that the transmitting function of the transmission/reception unit 34 may be separately provided as an advertisement-time change information transmitting unit. At this time, information indicating that the advertisement was presented to the user of a requested service even though the advertisement time was changed may be transmitted together with the advertisement-time change information to the user terminals 4.

Moreover, when an advertisement fee differs depending on a time slot for example, information that the advertisement fee and the like, are changed resulting from the change of the advertisement time may also be added to the advertisement-time change information and transmitted to the user terminals 4. Note that in order to make the values of the advertisement fee before and after the change transmittable to the user terminals 4, an original advertisement fee and the like, imposed on the advertiser may be included in the advertisement space information stored in the advertisement-space-information storage unit 322.

Furthermore, the arrival/departure-information determination unit 3110 may include a function of determining whether or not the scheduled boarding/disembarking place identifier included in the scheduled arrival/departure information matches the definite boarding/disembarking place identifier included in the definite arrival/departure information. A case in which it is determined that both boarding/disembarking place identifiers do not match is a case in which the arrival gate or the departure gate where the advertisement is displayed is changed in accordance with the actual arrival/departure status. The distribution management unit 312 of the advertisement distribution unit 31 distributes contents data to the output devices 2 disposed near the changed gate through the output control unit 3120 and the transmission/reception unit 34.

In this case, the distribution management unit 312 of the advertisement distribution unit 31 transmits, to the user terminals 4, advertisement-place change information indicating that the advertisement is output to the output devices 2 placed at the changed place regardless of largeness of the difference in time. Extraction of the user terminals 4 which is the transmission destination is same as the case of transmitting the advertisement-time change information. At this time, the information indicating that the advertisement was presented to the user of the service corresponding to the advertisement space even though the advertisement time was changed may be added to the advertisement-place change information and be transmitted to the user terminals 4.

The user terminals 4 is, for example, a general-purpose computer (e.g., a personal computer or the like), and can be used for not only receiving the above-described advertisement-time change information, advertisement-place change information, and the like from the advertisement distribution unit 31 and displaying those pieces of information to the client, but also exchanging other necessary information with the advertisement output control device 3. As an example, the user terminals 4 can be used at the time of an application for an advertisement. In this case, the client who places an advertisement browses the advertisement space information made available to the public over the Internet through the user terminal 4, selects the specific advertisement space from the advertisement space information, and transmits the selected advertisement space and contents data to the advertisement output control device 3. The advertisement-information acquisition unit 323 of the advertisement output control device 3 obtains the selected advertisement space and the contents data.

In this fashion, the advertisement space output control device 3 transmits an actual distribution result (an actual advertisement result) including the advertisement-time change information and the advertisement-place change information to the user terminals 4, and thus the client can confirm that the advertisement was presented to the users of the service corresponding to the advertisement space applied by the client.

### Other Embodiments

In the first embodiment and the second embodiment, the explanation is given of a case in which the advertisement output control system is applied to one airport, but the advertisement output control system may be applied to a plurality of airports so as to present an advertisement linked at both airports that are an arrival place and a departure place.

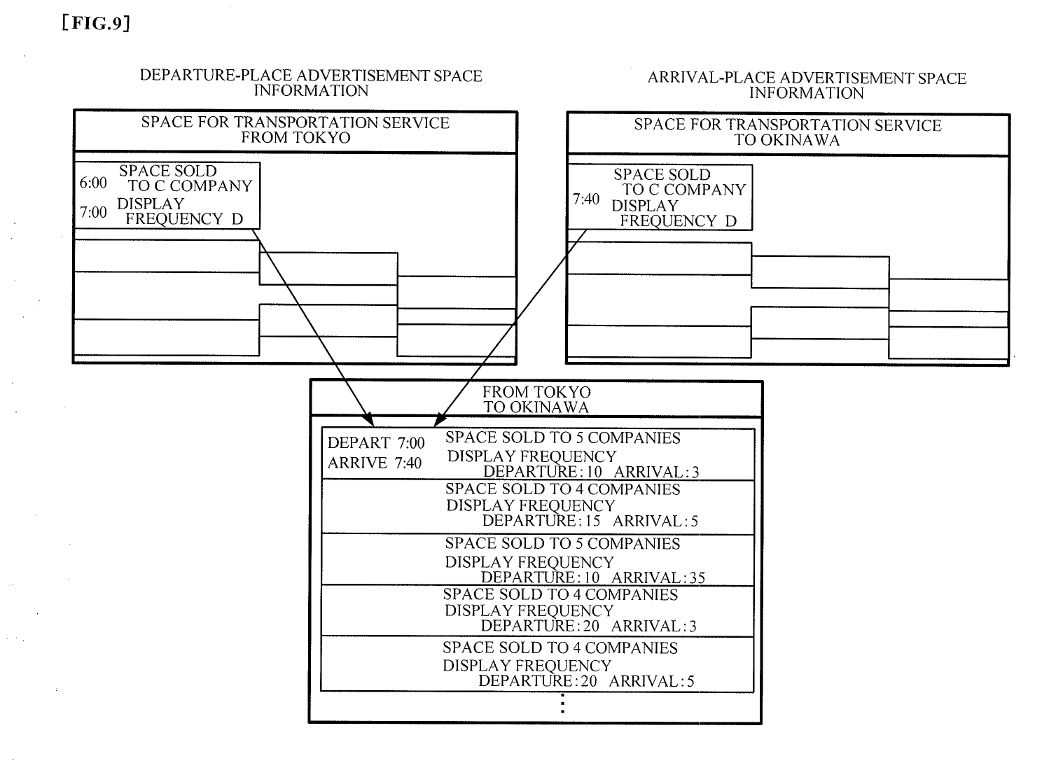

For example, as shown in FIG. 9, the distribution-request acceptance unit 32 generates the advertisement space information for the departure place (a departure-airport advertisement space) and the advertisement space information for an arrival place (an arrival-airport slot), which are linked with each other. Moreover, the distribution-request acceptance unit 32 presents such linked advertisement space information to the clients, thereby facilitating the applications for the advertisement spaces (purchase of the advertisement spaces) for both an arrival place and a departure place.

Next, when receiving, from the client, the applications for the advertisement spaces, based on both of the advertisement space information, the distribution-request acceptance unit 32 supplies the advertisement space information associated with contents to the advertisement distribution units 31 at the corresponding airports (the airports at the arrival place and the departure place).

At the corresponding airport, like the first embodiment, when receiving the definite arrival/departure information from the transportation service management device 1, the advertisement distribution unit 31 discretionally changes the advertisement schedule based on the definite arrival/departure time, and distributes contents to the output device 2 in accordance with the changed advertisement schedule. That is, the advertisement distribution unit 31 at the departure airport discretionally changes the advertisement schedule based on the definite departure time, and distributes the contents to the output device 2 which corresponds to the airport. Moreover, the advertisement distribution unit 31 at the arrival airport discretionally changes the advertisement schedule based on the definite arrival time, and distributes the contents to the output device 2 which corresponds to the airport.

In this case, since the advertisements which are linked at both an arrival place and a departure place can be presented to the users of the same service, the advertisement effect is further enhanced.

The present invention can be carried out with various changes and modifications in various forms, and is not limited to the above-described embodiments. For example, the present invention can be applied to the digital signage for the railroad, the route bus, or the like. in addition to the digital signage for the airport.

Moreover, the exemplary diagrams, flowcharts, and the like used for explaining the above-described embodiments can be discretionally changed without departing from the scope and spirit of the present invention.

Furthermore, the functions executed by the advertisement output control device 3 according to each of the above-described embodiments can be realized by not only software but also exclusive hardware. Moreover, the advertisement output control device 3 can also be realized by a normal computer system.

According to the above-described embodiments, the explanation is given of a case in which the advertisement output control device 3 stores the operation program in the ROM or the like in advance. However, a program that allows a device to execute the above-described process operation may be stored in a computer-readable recording medium, such as a flexible disc, a CD-ROM (Compact Disc Read-Only Memory), a DVD (Digital Versatile Disk), an MO (Magneto-Optical disk), or the like and may be installed in the computer in order to configure a device that executes the above-described process operations through the computer-readable recording medium distributed.

Moreover, the program may be stored at first in a disk device or the like of a predetermined server device over the communication network like the Internet, and may be superimposed on a carrier wave for example, in order to allow a computer to download the program. Furthermore, the above-described process can also be accomplished by activating and executing the program while the program is being transferred through a communication network. Still further, when, for example, the above-described functions are borne and realized by an OS (Operating System) or realized by the cooperative operation of the OS and an application, only the portions other than the OS may be stored in a medium and distributed, or may be downloaded to a computer for example.

This application is based on Japanese Patent Application No. 2009-173540 filed on Jul. 24, 2009. The entire specification, claims, and drawings of Japanese Patent Application No. 2009-173540 are incorporated herein by reference in this specification.

### INDUSTRIAL APPLICABILITY

According to the present invention, it is possible to provide the advertisement output control device, the advertisement output control system, the advertisement output control method, and the recording medium that are capable of appropriately enhancing the advertisement effect of an advertisement which is output at arrival/departure places of the vehicles.

### DESCRIPTION OF REFERENCE NUMERALS

1 Transportation service management device
2 (2-1 to 2-n) Output device
3 Advertisement output control device
4 (4-1 to 4-n) User terminal
9a to 9c Communication network
21 (21-1 to 21-n) Reception unit
22 (22-1 to 22-n) Display, unit
31 Advertisement distribution unit
32 Distribution-request acceptance unit
33 Transmission unit
34 Transmission/reception unit
311 Arrival/departure-slot supply unit
312 Distribution management unit
313 (313-1 to 313-n) Contents DB
314 Arrival/departure-information storage unit
321 Advertisement-space generation unit
322 Advertisement-space-information storage unit
323 Advertisement-information acquisition unit
3110 Arrival/departure-information acquisition unit
3111 Arrival/departure-information determination unit
3120 Output control unit
3210 Open-advertisement-space output unit
3230 Contents-data record unit

1. An advertisement output control device which is connected to, through a communication network, at least one output device that is placed at a boarding/disembarking place of a vehicle in an arrival/departure place (an arrival place or a departure place) of the vehicle, and which causes the output device to output contents data for an advertisement, the advertisement output control device comprising:
an arrival/departure-information acquisition unit that obtains scheduled arrival/departure information which is scheduled information relating to arrival and departure including a scheduled arrival/departure time of the vehicle at the arrival/departure place, and definite arrival/departure information which is definite information relating to arrival and departure including a definite arrival/departure time when the arrival/departure time of the vehicle at the arrival/departure place is fixed, the scheduled arrival/departure information obtained and definite arrival/departure information each being associated with a service identifier which identifies the service of the vehicle relating to arrival and departure;
an advertisement-space generation unit that generates advertisement space information which includes advertisement spaces, organized for a plurality of services, indicating time and time periods for outputting the contents data to the output device and associated with the service identifiers based on the scheduled arrival/departure information;
an advertisement-space-information storage unit that stores the advertisement space information where at least one advertisement space is associated with contents data for at least one advertisement to be output to the output device at the at least one advertisement space;
an open-advertisement-space output unit that outputs advertisement spaces, which are not associated with contents data in the advertisement space information stored in the advertisement-space-information storage unit, for making the advertisement spaces available to the public as open advertisement spaces;
an advertisement-information acquisition unit that obtains at least one advertisement space which is selected among the open advertisement spaces output by the open-advertisement-space output unit, and contents data for at least one advertisement, which are subjected to be output;
a contents-data record unit which updates the advertisement space information by associating the advertisement space with the contents data, both obtained by the advertisement-information acquisition unit, and which records the updated information in the advertisement-space-information storage unit;
a distribution management unit which generates a schedule for outputting the contents data to the output device as an advertisement schedule in association with the service identifier and the contents data based on the updated advertisement space information, and which changes, based on the definite arrival/departure information after obtaining the definite arrival/departure information, the advertisement schedule associated with a same service identifier as the service identifier associated with the definite arrival/departure information as a changed advertisement schedule; and
an output control unit that performs a control of outputting contents data associated with the changed advertisement schedule to the output device in accordance with the changed advertisement schedule.

2. The advertisement output control device according to claim 1, wherein
the advertisement schedule includes output time of the contents data to the output device,
the distribution management unit changes the output time of the advertisement schedule, based on the definite arrival/departure time obtained, to be the changed advertisement schedule, and
the output control unit outputs the contents data associated with the changed advertisement schedule to the output device in accordance with the changed output time.

3. The advertisement output control device according to claim 1, wherein
the output device is placed at each of a plurality of boarding/disembarking places of the vehicle,
the arrival/departure-information acquisition unit obtains the scheduled arrival/departure information and the definite arrival/departure information each being associated with the service identifier, together with a scheduled boarding/disembarking place identifier that identifies a scheduled boarding/disembarking place and a definite boarding/disembarking place identifier that identifies a definite boarding/disembarking place,
the advertisement-space generation unit generates the advertisement space information including the scheduled boarding/disembarking place identifier,
the distribution management unit sets the scheduled boarding/disembarking place identifier to be included in the advertisement schedule in association with the service identifier, and replaces the scheduled boarding/disembarking place identifier with the definite boarding/disembarking place identifier after the definite arrival/departure information is obtained, thereby setting the changed advertisement schedule, and
the output control unit outputs the contents data associated with the changed advertisement schedule to the output device which is placed at a boarding/disembarking place identified by the definite boarding/disembarking place identifier of the changed advertisement schedule.

4. The advertisement output control device according to claim 3, wherein
the open-advertisement-space output unit outputs the open advertisement space in association with the service identifier and the scheduled boarding/disembarking place identifier for making the open advertisement space available to the public, and
the scheduled boarding/disembarking place identifier included in the advertisement schedule is selected from the scheduled boarding/disembarking place identifier associated with the open advertisement space output for being made available to the public, and the scheduled disembarking place identifier is obtained by the advertisement-information acquisition unit.

5. The advertisement output control device according to claim 1, wherein
the output device is placed at each of a plurality of departure places of the vehicle arriving at the arrival place,
the arrival/departure-information acquisition unit obtains, for each service identifier, a departure place identifier for identifying the departure place of a service that is identified by the service identifier in association with the scheduled departure time of the service,
the advertisement-information acquisition unit further obtains the departure place identifier of the departure place at which an advertisement is desired, and
the output control unit performs a control so as to output the contents data subjected to be output based on the advertisement schedule to the output device at the departure place identified by the departure place identifier obtained by the advertisement-information acquisition unit in accordance with the changed advertisement schedule.

6. The advertisement output control device according to claim 1, wherein
the advertisement-space generation unit divides at least one advertisement space in the generated advertisement space information into a plurality of small advertisement spaces, and generates the advertisement space that includes the plurality of small advertisement spaces associated with the service identifiers respectively,
the advertisement-space-information storage unit stores the advertisement space information including the plurality of small advertisement spaces associated with the contents data for advertisements to be output to the output device respectively,
the open-advertisement-space output unit outputs at least one small advertisement space that is not associated with contents data among the small advertisement spaces stored in the advertisement-space-information storage unit as an open small advertisement space in order to make the small advertisement space available to the public,
the advertisement-information acquisition unit further obtains at least one small advertisement space selected among the open small advertisement spaces output from the open-advertisement-space output unit, and the contents data, for at least one advertisement, that are desired by the user to be output,
the contents-data record unit stores the at least one small advertisement space obtained by the advertisement-information acquisition unit in the advertisement-space-information storage unit in association with the contents data,
the distribution management unit generates the advertisement schedule and the changed advertisement schedule based on the advertisement space information including the small advertisement space associated with the contents data, and
the output control unit outputs the contents data associated with the small advertisement space to the output device in accordance with the changed advertisement schedule.

7. The advertisement output control device according to claim 1, wherein
the advertisement output control device is further connected to, through a communication network, a user terminal that is used by a user,
the advertisement output control device further includes an arrival/departure-information determination unit that determines whether or not a time difference of the departure times or a time difference of the departure times between the definite arrival/departure time and the scheduled arrival/departure time is equal to or greater than a predetermined threshold value, the definite arrival/departure time being obtained by the arrival/departure-information acquisition unit and the scheduled arrival/departure time corresponding to the service identifier of a service of a vehicle corresponding to the definite arrival/departure time obtained, and
when the arrival/departure-information determination unit determines that the time difference is equal to or greater than the predetermined threshold value, the output control unit further executes a control of transmitting, to the user terminal, advertisement-time change information indicating that output time of the contents data associated with the advertisement schedule to the output device is changed.

8. The advertisement output control device according to claim 7, wherein
the updated advertisement space information stored in the advertisement-space-information storage unit includes an advertisement fee when an advertisement is output in the advertisement space associated with the service identifier,
the open-advertisement-space output unit outputs the advertisement fee associated with the open advertisement space together with the open advertisement space, and
the output control unit executes a control of transmitting, to the user terminal used by the user of the advertisement space, advertisement-fee change information indicating that the advertisement fee is changed when the arrival/departure-information determination unit determines that the time difference is equal to or greater than the predetermined threshold value.

9. The advertisement output control device according to claim 7, wherein
the arrival/departure-information determination unit further determines whether or not the definite boarding/disembarking place identifier matches the scheduled boarding/disembarking place identifier included in the scheduled arrival/departure information having the service identifier that is same as the service identifier associated with the definite boarding/disembarking place identifier, and
the output control unit transmits, to the user terminal, advertisement-place change information indicating that an advertisement place is changed when it is determined that the scheduled boarding/disembarking place identifier does not match the definite boarding/disembarking place identifier.

10. (canceled)

11. An advertisement output control method of causing at least one output device to output contents data for an advertisement, the output device being connected to a communication network and being placed at a boarding/disembarking place of a vehicle in an arrival/departure place (an arrival place or a departure place) of the vehicle, the advertisement output control method comprising:
a scheduled arrival/departure-information acquisition step of obtaining, in association with a service identifier that identifies a service of the vehicle relating to arrival and departure, scheduled arrival/departure information which is scheduled information relating to arrival and departure, and including a scheduled arrival/departure time of the vehicle at the arrival/departure place;
an advertisement-space generation step of generating advertisement space information which includes advertisement spaces, organized for a plurality of services, indicating time and time periods for outputting the contents data to the output device associated with the service identifiers based on the scheduled arrival/departure information;
an advertisement-space-information storage step of storing the advertisement space information where at least one advertisement space is associated with contents data for an advertisement to be output to the output device at the at least one advertisement space;
an open-advertisement-space output step of outputting advertisement spaces, which are not associated with contents data in the advertisement space information stored through the advertisement-space-information storage step, for making the advertisement spaces available to the public as open advertisement spaces;
an advertisement-information acquisition step of obtaining at least one advertisement space which is selected among the open advertisement spaces output through the open-advertisement-space output step, and contents data for at least one advertisement, which are subjected to be output;
a contents-data record step of updating the advertisement space information by associating the advertisement space obtained through the advertisement-information acquisition step with the contents data, and of recording the updated information in a predetermined storage unit;
an advertisement-schedule generation step of generating a schedule for outputting the contents data to the output device as an advertisement schedule in association with the service identifier and the contents data based on the updated advertisement space information;
a definite arrival/departure-information acquisition step of obtaining, when an arrival/departure time of the vehicle at the arrival/departure place is fixed, definite arrival/departure information in association with a service identifier that identifies a service of the vehicle relating to arrival and departure, the definite arrival/departure information being information relating to the arrival and the departure, and including the definite arrival/departure time;
an advertisement-schedule change step of changing, after the definite arrival/departure information is obtained, the advertisement schedule associated with a same service identifier as the service identifier associated with the definite arrival/departure information based on the definite arrival/departure information as a changed advertisement schedule; and
an output control step of performing a control of outputting contents data associated with the advertisement schedule to the output device in accordance with the changed advertisement schedule.

12. A computer-readable recording medium storing a program that causes at least one output device to output contents data for an advertisement, the output device being connected to a communication network and being placed at a boarding/disembarking place of a vehicle in an arrival/departure place (an arrival place or a departure place) of the vehicle, the program causing a computer to execute:
a scheduled arrival/departure-information acquisition step of obtaining, in association with a service identifier that identifies a service of the vehicle relating to arrival and departure, scheduled arrival/departure information which is scheduled information relating to arrival and departure, and including a scheduled arrival/departure time of the vehicle at the arrival/departure place;
an advertisement-space generation step of generating advertisement space information which includes advertisement spaces, organized for a plurality of services, indicating time and time periods for outputting the contents data to the output device associated with the service identifiers based on the scheduled arrival/departure information;
an advertisement-space-information storage step of storing the advertisement space information where at least one advertisement space is associated with contents data for an advertisement to be output to the output device at the at least one advertisement space;
an open-advertisement-space output step of outputting advertisement spaces, which are not associated with contents data in the advertisement space information stored through the advertisement-space-information storage step, for making the advertisement space available to the public as an open advertisement space;
an advertisement-information acquisition step of obtaining at least one advertisement space which is selected among the open advertisement spaces output through the open-advertisement-space output step, and contents data for at least one an advertisement desired by the user which are subjected to be output;
a contents-data record step of updating the advertisement space information by associating the advertisement space obtained through the advertisement-information acquisition step with the contents data, and of recording the updated information in a predetermined storage unit;
an advertisement-schedule generation step of generating a schedule for outputting the contents data to the output device as an advertisement schedule in association with the service identifier and the contents data based on the updated advertisement space information;
a definite-arrival/departure-information acquisition step of obtaining, when an arrival/departure time of the vehicle at the arrival/departure place is fixed, definite arrival/departure information in association with a service identifier that identifies a service of the vehicle relating to arrival and departure, the definite arrival/departure information being information relating to the arrival and the departure, and including a definite arrival/departure time;
an advertisement-schedule change step of changing, after the definite arrival/departure information is obtained, the advertisement schedule associated with a same service identifier as the service identifier associated with the definite arrival/departure information based on the definite arrival/departure information as a changed advertisement schedule; and
an output control step of performing a control of outputting contents data associated with the advertisement schedule to the output device in accordance with the changed advertisement schedule.
